(19) United States
(12) Patent Application Publication
(10) Pub. No.: US 2024/0176940 A1
(43) Pub. Date: May 30, 2024

(54) DESIGN SUPPORT APPARATUS, DESIGN SUPPORT PROGRAM, AND DESIGN SUPPORT METHOD

(71) Applicants: FLOSFIA INC., Kyoto (JP); MITSUBISHI HEAVY INDUSTRIES, LTD., Tokyo (JP)

(72) Inventors: Masato Ito, Tokyo (JP); Masaya Mitake, Tokyo (JP); Kengo Takeuchi, Kyoto (JP); Toshimi Hitora, Kyoto (JP); Fujio Okui, Kyoto (JP)

(21) Appl. No.: 18/430,978

(22) Filed: Feb. 2, 2024

Related U.S. Application Data
(63) Continuation-in-part of application No. PCT/JP2022/029865, filed on Aug. 3, 2022.

(30) Foreign Application Priority Data
Aug. 4, 2021 (JP) 2021-128632

(51) Int. Cl. G06F 30/392

(52) U.S. Cl. CPC G06F 30/392

(57) ABSTRACT

Provided is a design support apparatus that supports design of an electronic component embedded substrate, the apparatus including: a height difference calculating unit that calculates a difference between the height of a first electronic component and the height of a second electronic component on the basis of first component information containing height information about the first electronic component to be incorporated in an electronic component embedded substrate and second component information containing height information about the second electronic component to be incorporated in the electronic component embedded substrate; and a height adjustment necessity judging unit that compares the difference with a reference value set in advance, and judges the necessity of a height adjusting member to be arranged on the first electronic component and/or the second electronic component.

### CROSS REFERENCE TO RELATED APPLICATION

This application is a continuation-in-part application of International Patent Application No. PCT/JP2022/029865 (Filed on Aug. 3, 2022), which claims the benefit of priority from Japanese Patent Application No. 2021-128632 (filed on Aug. 4, 2021).

The entire contents of the above applications, which the present application is based on, are incorporated herein by reference.

### 1. FIELD OF THE INVENTION

The disclosure relates to a design support apparatus, a design support program, and a design support method that support design of an electronic component embedded substrate with an embedded electronic component such as a semiconductor component.

### 2. DESCRIPTION OF THE RELATED ART

Automatically designing a printed board has been examined, and a design support method giving consideration to the shape or dimension of a component as one of design elements has been suggested. For example, according to a disclosed design support system, the necessity of a pressing jig for manufacture of a printed board is judged on the basis of height information about a housing to house the printed board and height information about a component to be incorporated in the printed board. There is also a disclosed printed board design apparatus including: component interference check means that judges whether components are to interfere with each other on the basis of component data about the respective positions, outer shapes, and heights of the components to be mounted between printed boards in a pair facing each other, and board space data about space between the printed boards; and output means that outputs result obtained by the component interference check means.

On the other hand, from the viewpoint of reducing the size and thickness of a circuit board module used for electronic equipment, an electronic component embedded substrate with an internally embedded electronic component such as a power semiconductor element has been suggested. At the electronic component embedded substrate, the internally embedded electronic component and wiring formed on a surface of the electronic component embedded substrate are connected to each other through a via conductor (or a pad) formed at the substrate, for example. As an example, a disclosed electronic component embedded substrate includes an embedded power element, an embedded control element, and an embedded coil.

### SUMMARY OF THE INVENTION

According to an example of the present disclosure, there is provided a design support apparatus that supports design of an electronic component embedded substrate, the apparatus including: a height difference calculating unit that calculates a difference between the height of a first electronic component and the height of a second electronic component on the basis of first component information containing height information about the first electronic component to be incorporated in an electronic component embedded substrate and second component information containing height information about the second electronic component to be incorporated in the electronic component embedded substrate; and a height adjustment necessity judging unit that compares the difference with a reference value set in advance, and judges the necessity of a height adjusting member to be arranged on the first electronic component and/or the second electronic component.

According to an example of the present disclosure, there is provided a design support program that supports design of an electronic component embedded substrate, the program causing a computer to perform: a height difference calculating process of calculating a difference between the height of a first electronic component and the height of a second electronic component on the basis of first component information containing height information about the first electronic component to be incorporated in an electronic component embedded substrate and second component information containing height information about the second electronic component to be incorporated in the electronic component embedded substrate; and a height adjustment necessity judging process of comparing the difference with a reference value set in advance, and judging the necessity of a height adjusting member.

According to an example of the present disclosure, there is provided a design support method of supporting design of an electronic component embedded substrate, the method including at least: calculating a difference between the height of a first electronic component and the height of a second electronic component on the basis of first component information containing height information about the first electronic component to be incorporated in an electronic component embedded substrate and second component information containing height information about the second electronic component to be incorporated in the electronic component embedded substrate; and comparing the difference with a reference value set in advance, and judging the necessity of a height adjusting member.

Thus, in the present disclosure, even in a case of embedding a plurality of electronic components of different heights in a component embedded substrate, it is still possible to judge the necessity of height adjustment and make detailed design of a height adjusting member in a short time. This makes it possible to easily design an electronic component embedded substrate using electronic components of different heights while ensuring a degree of freedom of electronic component selection.

### BRIEF DESCRIPTION OF THE DRAWINGS

FIG. 1 is a block diagram illustrating the configuration of a design support apparatus according to a first embodiment.

FIG. 2 is a flowchart illustrating a processing procedure of a design support method according to the first embodiment.

FIG. 3 is a schematic drawing explaining a component database.

FIG. 4A is a sectional view schematically illustrating an example of a first electronic component according to an embodiment of the disclosure.

FIG. 4B is a top view schematically illustrating an example of a first electronic component according to an embodiment of the disclosure.

FIG. 5A is a sectional view schematically illustrating an example of a second electronic component according to an embodiment of the disclosure.

FIG. 5B is a top view schematically illustrating an example of a second electronic component according to an embodiment of the disclosure.

FIG. 6 is a view schematically illustrating an example of an electronic component embedded substrate according to an embodiment of the disclosure.

FIG. 7 is a block diagram illustrating the configuration of a design support apparatus according to a second embodiment.

FIG. 8 is a flowchart illustrating a processing procedure of a design support method according to the second embodiment.

FIG. 9 is a block diagram illustrating the configuration of a design support apparatus according to a third embodiment.

FIG. 10 is a flowchart illustrating a processing procedure of a design support method according to the third embodiment.

### DETAILED DESCRIPTION

In a case of embedding a plurality of semiconductor components in the same level of a multilayer substrate at a conventional electronic component embedded substrate, for example, it may be necessary to provide a fit between the heights of these electronic components and then embed these electronic components in the multilayer substrate. The present inventors have found that manually judging the necessity of a height adjusting member or determining the dimension thereof in this case causes a problem that much time and labor will be required. There is also a problem that a degree of freedom of selection of electronic components to be incorporated in a substrate will be limited if only electronic components of the same height are allowed to be arranged in the same layer.

As a result of earnest examination made to achieve the above-described object, the present inventors have found that the above-described problem is solvable by each example of the present disclosure.

Embodiments of the present disclosure will be described below with reference to the accompanying drawings. In the following description, the same parts and components are designated by the same reference numerals. The present embodiment includes, for example, the following disclosures.

### [Structure 1]

A design support apparatus that supports design of an electronic component embedded substrate, the apparatus including: a height difference calculating unit that calculates a difference between the height of a first electronic component and the height of a second electronic component on the basis of first component information containing height information about the first electronic component to be incorporated in an electronic component embedded substrate and second component information containing height information about the second electronic component to be incorporated in the electronic component embedded substrate; and a height adjustment necessity judging unit that compares the difference with a reference value set in advance, and judges the necessity of a height adjusting member to be arranged on the first electronic component and/or the second electronic component.

### [Structure 2]

The design support apparatus according to [Structure 1], wherein the height adjustment necessity judging unit selects an electronic component where the height adjusting member is to be arranged.

### [Structure 3]

The design support apparatus according to [Structure 1] or [Structure 2], further including: a height adjusting member dimension calculating unit that calculates a dimension of the height adjusting member.

### [Structure 4]

The design support apparatus according to any of [Structure 1] to [Structure 3], wherein the first electronic component and the second electronic component are bare chips, and the height information about the first electronic component and the height information about the second electronic component are height information about the respective bare chips.

### [Structure 5]

The design support apparatus according to any of [Structure 1] to [Structure 4], further including: a height adjusting member arrangement method selecting unit that selects an arrangement method of arranging the height adjusting member.

### [Structure 6]

The design support apparatus according to [Structure 5], wherein the first component information and the second component information, or the first component information or the second component information contains availability condition information about the first electronic component and/or the second electronic component, and the height adjusting member arrangement method selecting unit selects the arrangement method of arranging the height adjusting member on the basis of the availability condition information.

### [Structure 7]

The design support apparatus according to any of [Structure 1] to [Structure 6], further including: an input device for inputting component identifying information about the first electronic component and component identifying information about the second electronic component.

### [Structure 8]

The design support apparatus according to any of [Structure 1] to [Structure 7], including: a component information acquiring unit that acquire component information containing the height information about the first electronic component and the height information about the second electronic component from a component database on the basis of the component identifying information about the first electronic component and the component identifying information about the second electronic component accepted by the input device.

### [Structure 9]

The design support apparatus according to any of [Structure 1] to [Structure 8], wherein the first electronic component and the second electronic component are power devices.

### [Structure 10]

The design support apparatus according to any of [Structure 1] to [Structure 9], wherein the first electronic component is a rectifier element and the second electronic component is a switching element.

### [Structure 11]

The design support apparatus according to any of [Structure 1] to [Structure 10], further including: an output device that outputs result of judgment by the height adjustment necessity judging unit.

### [Structure 12]

A design support program that supports design of an electronic component embedded substrate, the program causing a computer to perform: a height difference calculating process of calculating a difference between the height of a first electronic component and the height of a second electronic component on the basis of first component information containing height information about the first electronic component to be incorporated in an electronic component embedded substrate and second component information containing height information about the second electronic component to be incorporated in the electronic component embedded substrate; and a height adjustment necessity judging process of comparing the difference with a reference value set in advance, and judging the necessity of a height adjusting member.

### [Structure 13]

A design support method of supporting design of an electronic component embedded substrate, the method including at least: calculating a difference between the height of a first electronic component and the height of a second electronic component on the basis of first component information containing height information about the first electronic component to be incorporated in an electronic component embedded substrate and second component information containing height information about the second electronic component to be incorporated in the electronic component embedded substrate; and comparing the difference with a reference value set in advance, and judging the necessity of a height adjusting member.

A design support apparatus according to an embodiment of the disclosure is characterized in that the design support apparatus includes: a height difference calculating unit that calculates a difference between the height of a first electronic component and the height of a second electronic component on the basis of first component information containing height information about the first electronic component to be incorporated in an electronic component embedded substrate and second component information containing height information about the second electronic component to be incorporated in the electronic component embedded substrate; and a height adjustment necessity judging unit that compares the difference with a reference value set in advance, and judges the necessity of a height adjusting member to be arranged on the first electronic component and/or the second electronic component.

While embodiments of the design support apparatus of the disclosure will be described below using the drawings, the disclosure is not limited to these embodiments.

### First Embodiment

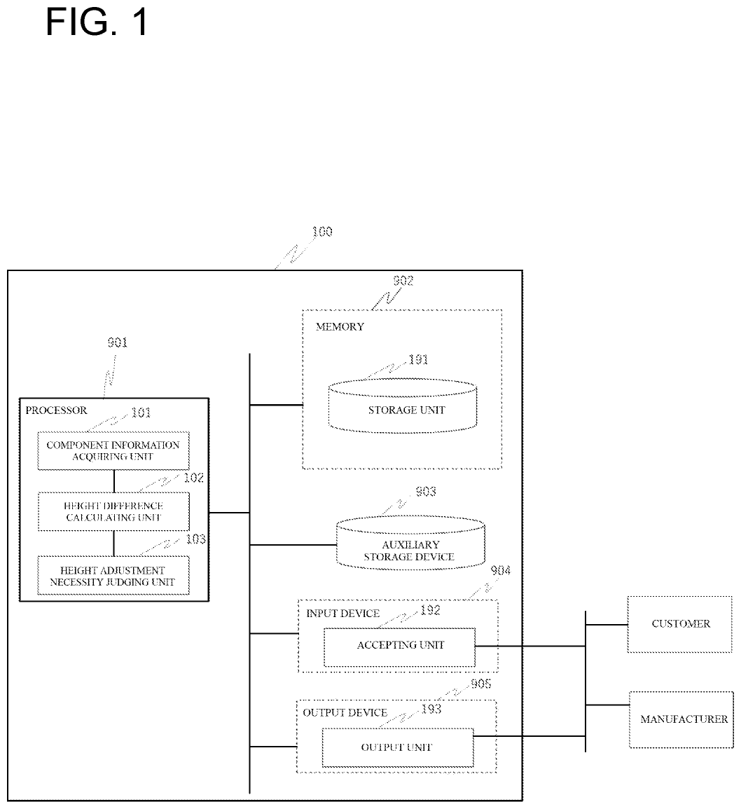

A design support apparatus 100 in FIG. 1 is a computer with hardware including a processor 901, a memory 902, an auxiliary storage device 903, an input device 904, and an output device 905. The processor 901 is connected to the other hardware through a signal line.

The processor 901 is an IC (integrated circuit) that performs processing and controls the other hardware. More specifically, the processor 901 is a CPU (central processing unit), a DSP (digital signal processor), or a GPU (graphics processing unit). The memory 902 is a volatile storage device. The memory 902 is also called a main storage device or a main memory. More specifically, the memory 902 is a RAM (random access memory).

The auxiliary storage device 903 is a nonvolatile storage device. More specifically, the auxiliary storage device 903 is a ROM (read only memory) or an HDD (hard disc drive). The input device 904 is a device to accept an input. More specifically, the input device 904 is a keyboard, a mouse, a numeric keypad, or a touch panel, for example. In an embodiment of the disclosure, the input device 904 may be a device connected through a network to an external customer's terminal, for example, and may accept information input by an external designer (customer) using an accepting unit 192. The information input to the input device 904 may be supplied as digital information through a network, for example. As a more specific example, the information input to the input device 904 may be information (digital information) input from the customer's terminal and supplied through the network.

The output device 905 is a device to produce an output. More specifically, the output device 905 is a monitor to make a display or a printer to produce a print, for example. In an embodiment of the disclosure, the output device may be a device connected through a network to an external customer's terminal, for example, and may be configured in such a manner as to allow display of output information through an output unit 193 on a display of a terminal belonging to an external designer (customer), for example. The information output by the output device 905 may be supplied as digital information through a network, for example. As a more specific example, the information output by the output device 905 may be displayed through a network on a customer's terminal or on a display of a manufacturer, for example.

The design support apparatus 100 includes “units” provided as elements forming a functional configuration including a component information acquiring unit 101, a height difference calculating unit 102, and a height adjustment necessity judging unit 103. The functions of the “units” are realized using software. The functions of the “units” will be described later.

The auxiliary storage device 903 stores a program for realizing the functions of the “units.” The program for realizing the functions of the “units” is loaded on the memory 902 and executed by the processor 901. The auxiliary storage device 903 further stores an OS (operating system). At least part of the OS is loaded on the memory 902 and run by the processor 901. Specifically, the processor 901 executes the program for realizing the functions of the “units” while running the OS.

Data obtained by executing the program for realizing the functions of the “units” is stored into a storage device that may be the memory 902, the auxiliary storage device 903, a register in the processor 901, or a cache memory in the processor 901. The design support apparatus 100 may include a plurality of processors 901 and these processors 901 may work together to execute the program for realizing the functions of the “units.”

The memory 902 functions as a storage unit 191 storing data. However, a storage device other than the memory 902 may function as the storage unit 191. The input device 904 functions as the accepting unit 192 that accepts an input. The output device 905 functions as the output unit 193 that produces an output.

The “units” may be read as “processes” or as “steps.” The functions of the “units” may be realized using firmware. The program for realizing the functions of the “units” may be stored into a nonvolatile storage medium such as a magnetic disk, an optical disk, or a flash memory.

The operation of the design support apparatus 100 corresponds to a design support method. A procedure of the design support method corresponds to a procedure of a design support program.

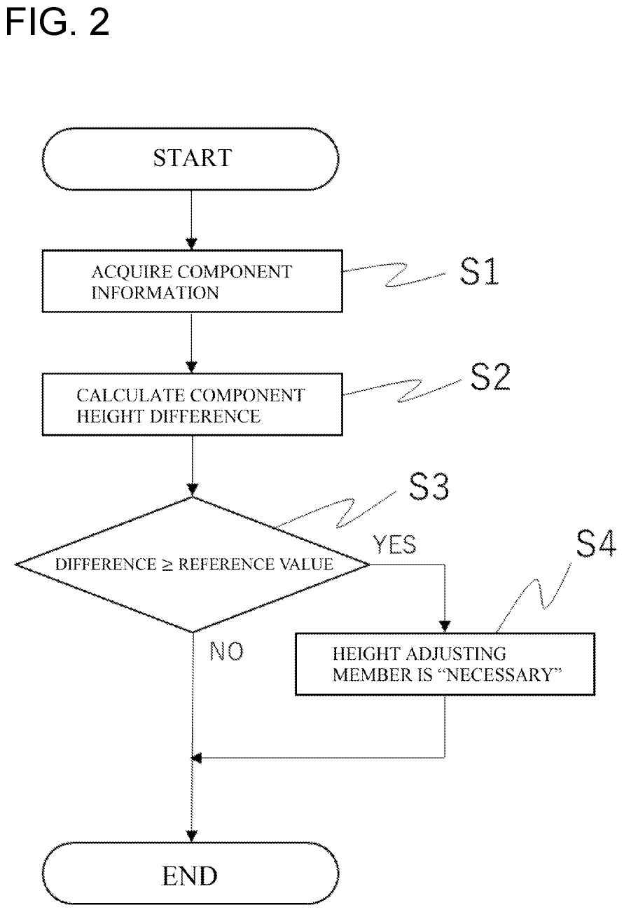

The operation of the design support apparatus 100 (design support method) will be described on the basis of FIG. 2.

In step S1, on the basis of component identifying information about a first electronic component and component identifying information about a second electronic component both to be incorporated in an electronic component embedded substrate, the component information acquiring unit 101 acquires first component information containing height information about the first electronic component and second component information containing height information about the second electronic component from a component database stored in the storage unit 191. The component identifying information about the first electronic component and the component identifying information about the second electronic component are information identifying the first electronic component and the second electronic component. As a more specific example, the component identifying information is a component identifier (such as a component name) of the first electronic component and/or the second electronic component. The component identifying information may be information selected and input by an external designer (customer) from the input device 904 or from an external terminal belonging to the designer (customer), and accepted by the accepting unit 192. In the present specification, a designer to perform operation on the processor, etc. is called an “internal designer,” a designer to perform operation on an external terminal, etc. connected to the design support apparatus through a network or the like is called an “external designer,” and the internal designer and the external designer are also collectively called a designer.

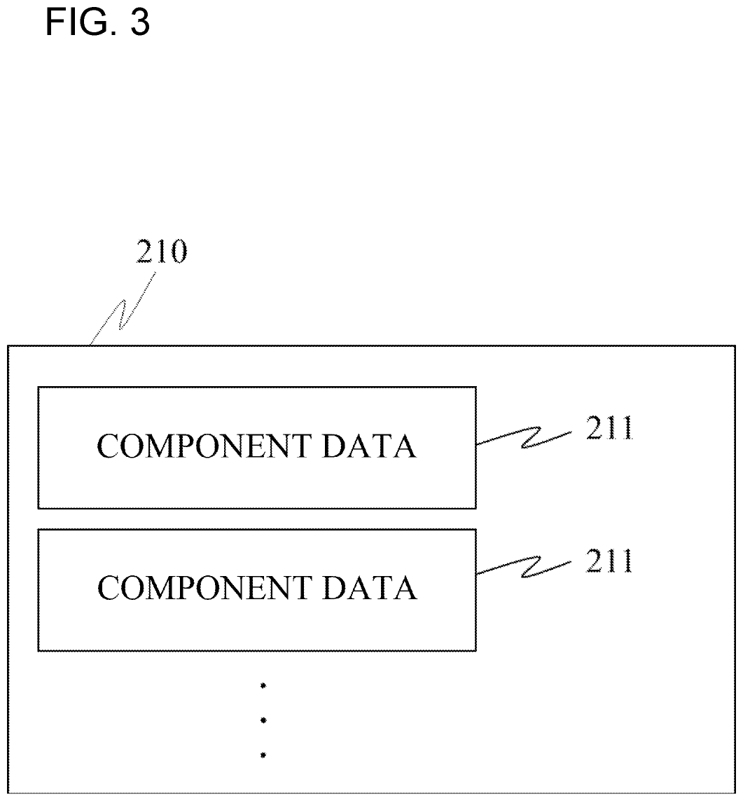

The component database will be described using FIG. 3. A component database 210 illustrated in FIG. 3 is a group of pieces of component data and is stored in advance in the storage unit 191. Component data 211 contains information about a component such as an identifier of a component (component identifying information) and an outer shape of the component (including the height of the component). The component identifier (component identifying information) indicates information usable for identifying each component such as the name of the component, for example. The outer shape of the component indicates the shape and size of the component. In an embodiment of the disclosure, the outer shape of the component contains information about the shape and size of the component as a bare chip. In an embodiment of the disclosure, the first electronic component is a bare chip and height information about the first electronic component is preferably information about the height of the first electronic component as the bare chip. In an embodiment of the disclosure, the second electronic component is a bare chip and height information about the second electronic component is preferably information about the height of the second electronic component as the bare chip.

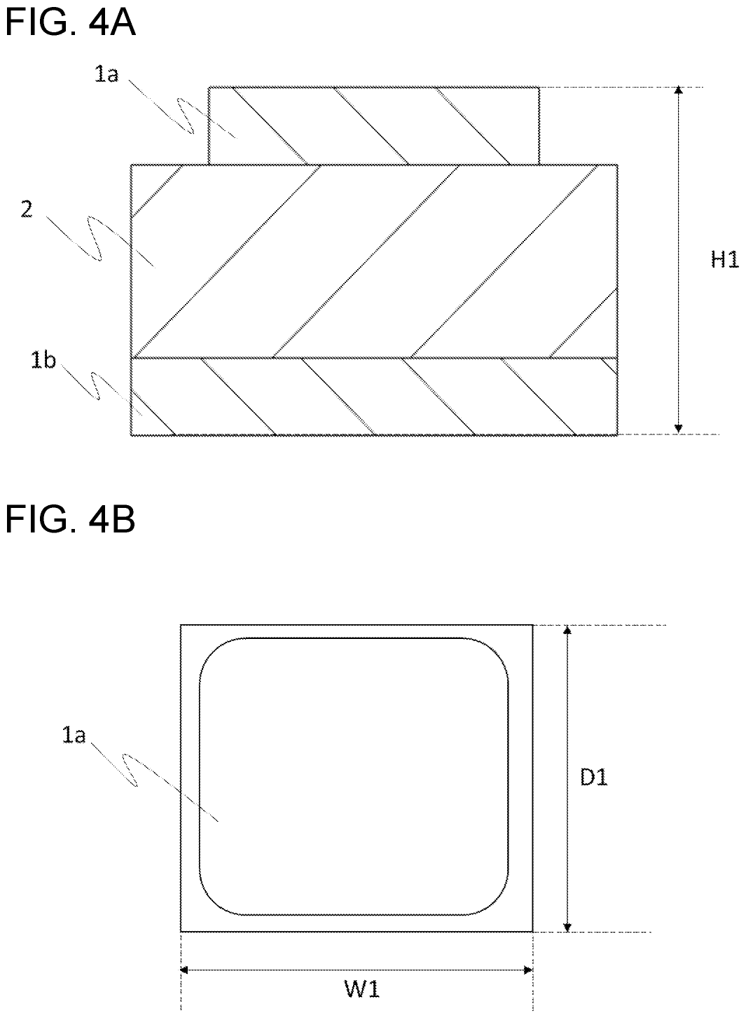

Next, the first and/or second component information (hereinafter also called “component information” simply) will be described in more detail. FIGS. 4A and 4B schematically illustrates a semiconductor component (electronic component) used in an embodiment of the disclosure. FIGS. 4A and 4B illustrates an example of a case where the first electronic component is a diode. FIG. 4A illustrates a sectional view and FIG. 4B illustrates a top view. The component information generally contains height information (a height H1 in FIG. 4A) about the first electronic component. More specifically, the height information H1 about the first electronic component indicates a total value of the heights of a Schottky electrode 1a, a semiconductor layer 2, and an ohmic electrode 1b. In an embodiment of the disclosure, the component information preferably contains information about a chip size (a depth D1 and a width W1 in FIG. 4B) of the first electronic component. The chip size information is used preferably in a second embodiment described later.

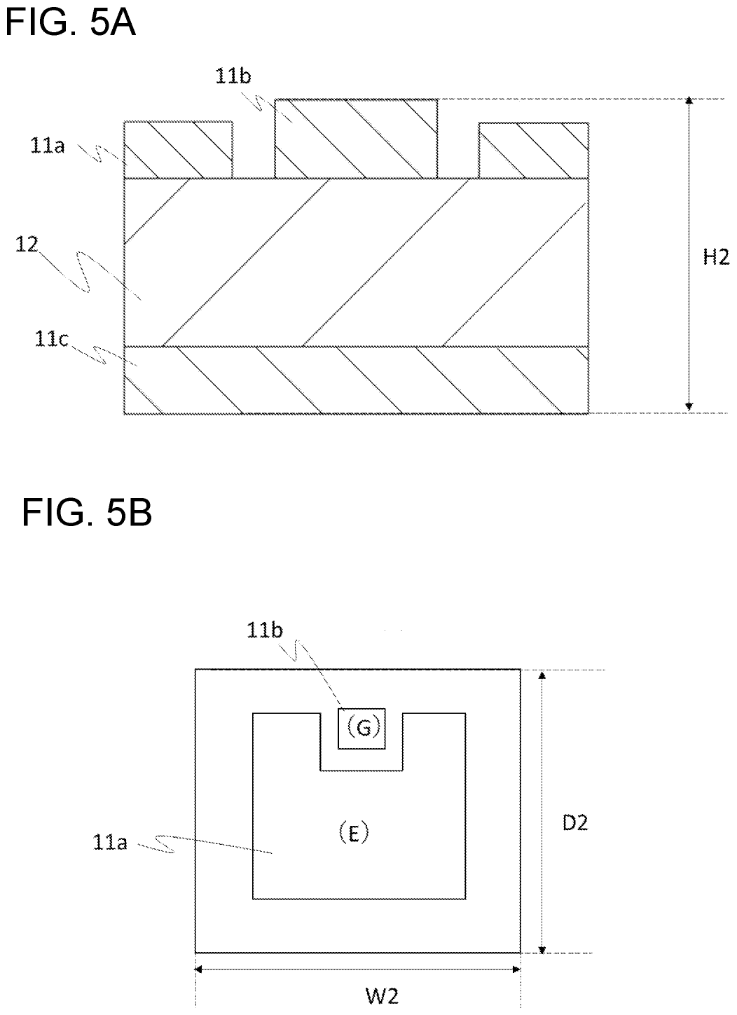

FIG. 5 illustrates an example of a case where the second electronic component is a switching element (IGBT). FIG. 5(a) illustrates a sectional view and FIG. 5(b) illustrates a top view. The component information generally contains height information (a height H2 in FIG. 5(a)) about the second electronic component. More specifically, the height information H2 about the second electronic component indicates a total value of the heights of an emitter electrode 11a or a gate electrode 11b, a semiconductor layer 12, and a collector electrode 11c. In an embodiment of the disclosure, the component information preferably contains information about a chip size (a depth D2 and a width W2 in FIG. 5(b)) of the second electronic component. The chip size information is used preferably in the second embodiment described later.

In the examples illustrated in FIGS. 4 and 5, the electronic components are active components (vertical devices). However, the disclosure is not limited to this. The first and/or the second electronic component may be a lateral device or a passive component. In an embodiment of the disclosure, if the first and second electronic components are power devices (particularly, vertical devices), it is more important to incorporate the first and second electronic components in the electronic component embedded substrate after a fit is provided between the heights of the first and second electronic components from the viewpoint of electrical and/or thermal connection to the substrate. Furthermore, if the first and second electronic components are vertical devices as illustrated in FIGS. 4 and 5, it is still more important to provide a fit between the heights of the first and second electronic components from the viewpoint of electrical and/or thermal connections of upper and lower electrodes of each of the electronic components to substrates facing these electrodes. In an embodiment of the disclosure, even if the first and second electronic components are different from each other like in a case where the first electronic component is a rectifier element (diode, for example) and the second electronic component is a switching element (MOSFET or IGBT, for example), it is still possible to judge the necessity of a height adjusting member and calculate the dimension thereof within a short time while ensuring a degree of freedom of electronic component selection.

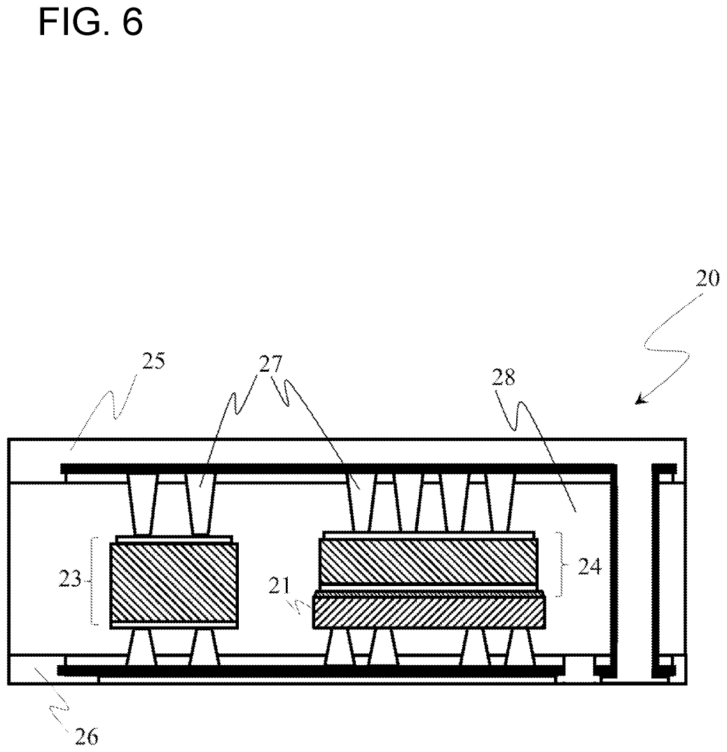

FIG. 6 is a sectional view schematically illustrating an example of an electronic component embedded substrate designed by the design support apparatus of the disclosure that supports design of an electronic component embedded substrate. The electronic component embedded substrate in FIG. 6 includes at least a first semiconductor component 23, a second semiconductor component 24, a height adjusting member 21, substrates (conductive layers) 25 and 26, a resin 28, and a via 27. As illustrated in FIG. 6, in designing the electronic component embedded substrate, the design support apparatus of the disclosure makes it possible to judge the necessity and determine the dimension of the height adjusting member 21 in a short time without requiring manual operation. The electronic component embedded substrate in FIG. 6 is illustrated as an example of a case where a system of connecting the embedded components and the substrate is a via connection system. However, the disclosure is not limited to this. In an embodiment of the disclosure, the system of connecting the embedded components and the substrate may be a pad connection system. The height adjusting member 21 may be a plate-like member such as a metallic plate, a ceramic plate, a conductive substrate, an insulator substrate, or a semiconductor substrate. The height adjusting member 21 may also be a film-like member formed by a working (film deposition) process such as plating.

In step S2, the height difference calculating unit 102 calculates a value of a difference between the height of the first electronic component and the height of the second electronic component on the basis of the first component information containing the height information about the first electronic component and the second component information containing the height information about the second electronic component. More specifically, the difference is calculated by subtracting the value of the smaller one of the heights of the first electronic component and the second electronic component from the value of the larger height. As a more specific example, if the height of the first electronic component is larger than the height of the second electronic component, a value obtained by subtracting the height value of the second electronic component from the height value of the first electronic component is calculated as a value of the difference between the heights. The calculated value of the difference between the heights is written into the storage unit 191.

In step S3, the height adjustment necessity judging unit 103 compares the difference value calculated by the height difference calculating unit 102 with a reference value, and judges whether a height adjusting member is necessary. In the present embodiment, a value to be set as the reference value is 10% of the value of the smaller one of the heights of the first electronic component and the second electronic component, for example. Specifically, if the height of the first electronic component is larger than the height of the second electronic component, a value corresponding to 10% of the height of the second electronic component is set as the reference value. In this case, if a difference between the height of the first electronic component and the height of the second electronic component is equal to or greater than 10% of the height of the second electronic component, a height adjusting member is judged to be necessary. If the difference is less than 10%, a height adjusting member is judged to be unnecessary. In an embodiment of the disclosure, the height adjustment necessity judging unit 103 determines an electronic component where a height adjusting member is to be arranged. As a more specific example, of the first electronic component and the second electronic component, the height adjustment necessity judging unit determines an electronic component of a smaller height to be the electronic component where the height adjusting member is to be arranged. Table 1 illustrates examples of the height difference, the reference value, and judgment result about the necessity of the height adjusting member. The reference value (10%, for example) is stored in advance in the storage unit 191.

TABLE 1

| Height | Height | | | |
|---|---|---|---|---|
| of first | of second | | | Judgment |
| semiconductor | semiconductor | Height | Reference | result |
| component | component | difference | value | about |
| (μm) | (μm) | (μm) | (μm) | necessity |
| 200 | 180 | 20 | 18 | Necessary |
| 180 | 86 | 114 | 8.6 | Necessary |

In an embodiment of the disclosure, the height adjustment necessity judging unit 103 may determine to arrange height adjusting members at both the first electronic component and the second electronic component. As a more specific example of such a case, if a difference between the heights of the first and second electronic components is small (equal to or less than a certain reference value), if a metallic plate is to be used as a height adjusting member, and if there is difficulty, for example in obtaining a metallic plate of a thickness equal to or less than the certain reference value, metallic plates of different thicknesses are arranged at both the first and second electronic components to make height adjustment. In this case, the above-described certain reference value is preferably stored in advance in the storage unit 191. Judgment as to whether to use a metallic plate as the height adjusting member will be explained in more detail in a third embodiment described later.

In the case described as an example in the present embodiment, the number of components to be incorporated in the electronic component embedded substrate is two. However, the disclosure is not limited to the case where the number of the components is two but the number of the components may be three or more. If the number of the components is three or more, a difference is calculated between the height of a component of the three or more components having the largest height value and the height of each of the other components in step S2, for example. In step S3, the calculated difference and a reference value set in advance are compared with each other, and the necessity of a height adjusting member is judged in terms of a relationship between the component of the largest height value and each of the other components.

Judgment result about the necessity of height adjustment thereby obtained is output using the output device 905. In an embodiment of the disclosure, the judgment result about the necessity of height adjustment may be output together with other design information from the output device 905 to an external terminal (a terminal belonging to a manufacturer, for example) through a network or the like. In an embodiment of the disclosure, the judgment result about the necessity of height adjustment may be output as CAD data, for example, together with other design information.

By realizing the above-described configuration belonging to the design support apparatus (design support method) using software, it becomes possible to obtain a design support program having a comparable function. More specifically, a design support program that supports design of an electronic component embedded substrate, which is also provided as one configuration of the disclosure, causes a computer to perform: a height difference calculating process of calculating a difference between the height of a first electronic component and the height of a second electronic component on the basis of first component information containing height information about the first electronic component to be incorporated in an electronic component embedded substrate and second component information containing height information about the second electronic component to be incorporated in the electronic component embedded substrate; and a height adjustment necessity judging process of comparing the difference with a set reference value, and judging the necessity of a height adjusting member.

As described above, according to the present embodiment, it is possible to easily design an electronic component embedded substrate using electronic components of different heights while ensuring a degree of freedom of electronic component selection.

The details of the steps and the order of implementation of the steps in the present embodiment are given merely as examples, and the disclosure is not limited to the examples given above. This also applies to embodiments described below.

### Second Embodiment

A second embodiment of the disclosure will be described below by referring to the drawings. Description to overlap the one given in the first embodiment will be omitted or simplified.

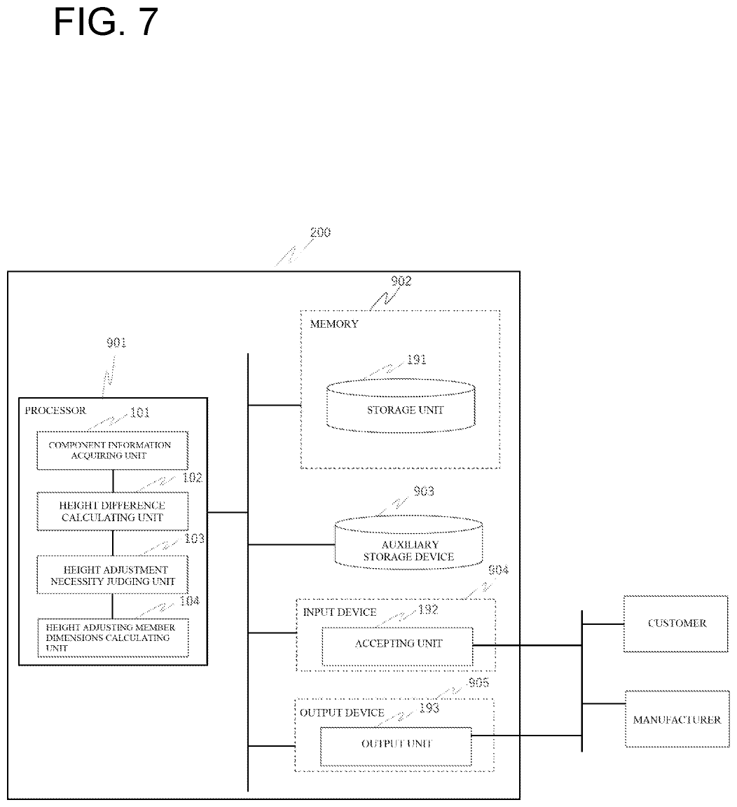

FIG. 7 is a block diagram illustrating the configuration of a design support apparatus according to the second embodiment of the disclosure. A unit corresponding to that of the first embodiment is given the same sign. A unit functioning in the same way as in the first embodiment will not be described. The design support apparatus illustrated in FIG. 7 differs from the design support apparatus in FIG. 1 in that a height adjusting member dimension calculating unit 104 is further provided.

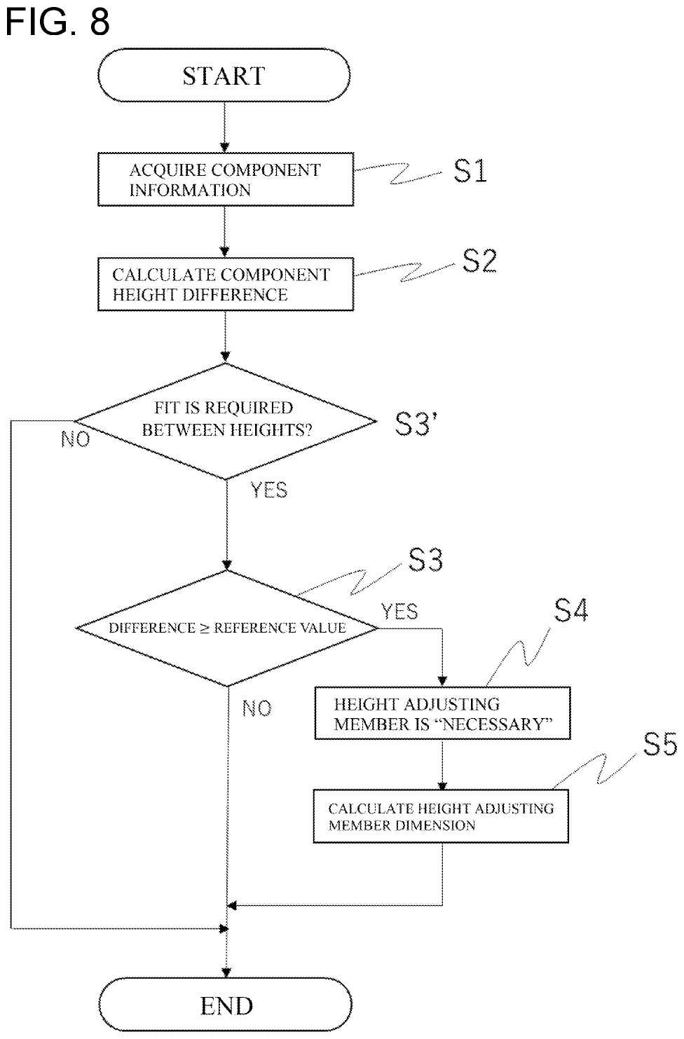

The operation of a design support apparatus 200 (design support method) according to the second embodiment of the disclosure will be described below using FIG. 8. A processing flow of the design support method according to the present embodiment is the same as that of the first embodiment except step S3′ and step S5. In step S3′, the height adjustment necessity judging unit 103 judges whether a fit between heights is necessary on the basis of first component information and second component information, for example. A criterion for the judgment is preferably stored in advance in the storage unit 191. The judgment criterion is that whether the first electronic component and the second electronic component are both vertical devices, for example. In this case, the first component information and the second component information contain information usable for judging whether the first and second electronic components are vertical devices each including electrodes at both upper and lower surfaces of the device. In an embodiment of the disclosure, even if one of the first and second electronic components is not a vertical device, it may still be judged whether a fit is required between the heights of the first and second electronic components on the basis of calculation result about thermal resistance and from the viewpoint of thermal connectivity of each of the first and second electronic components to substrates over and under the electronic component, for example.

In step S5, the height adjusting member dimension calculating unit 104 calculates the dimension (height, width, depth) of a height adjusting member. The calculated dimension is written into the storage unit 191. For example, a difference between the height of the first electronic component and the height of the second electronic component calculated by the height difference calculating unit is used as it is as the height of the height adjusting member. If three or more electronic components are to be subjected to height adjustment, a difference in height between an electronic component where a height adjusting member is to be arranged and an electronic component of the largest height is calculated as the height of the height adjusting member for the corresponding electronic component. The width and depth of the height adjusting member are calculated by multiplying the width and depth of the corresponding electronic component by mounting factors. The mounting factors are set in advance as values to be considered under manufacturing conditions and stored in the storage unit 191.

Judgment result about the necessity of height adjustment and calculation result about the dimension of the height adjusting member thereby obtained are output using the output device 905. In an embodiment of the disclosure, the judgment result about the necessity of height adjustment and the calculation result about the dimension of the height adjusting member may be output together with other design information from the output device 905 to an external terminal (a terminal belonging to a manufacturer, for example) through a network or the like. In an embodiment of the disclosure, the judgment result about the necessity of height adjustment may be output as CAD data (a drawing for design), for example, together with other design information.

As described above, according to the present embodiment, if there is a need for a height adjusting member, the dimension of the height adjusting member is calculated automatically. This makes it possible to make thermal design (calculate thermal resistance, for example) or perform subsequent manufacturing processes smoothly. This effect becomes more notable, particularly if strict thermal design is required (if the first and second electronic components are power devices, for example).

### Third Embodiment

A third embodiment of the disclosure will be described below by referring to the drawings. Description to overlap the one given in the first embodiment or the second embodiment will be omitted or simplified.

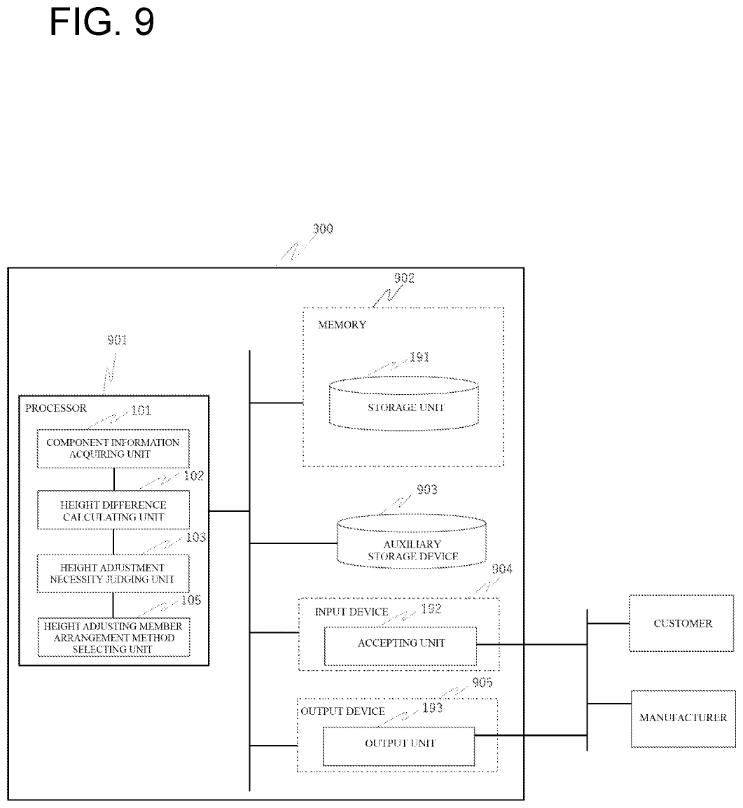

FIG. 9 is a block diagram illustrating the configuration of a design support apparatus according to the third embodiment of the disclosure. A unit corresponding to those of the first and second embodiments is given the same sign. A unit functioning in the same way as in the first or second embodiment will not be described. The design support apparatus illustrated in FIG. 9 differs from that of the first embodiment in that a height adjusting member arrangement method selecting unit is further provided.

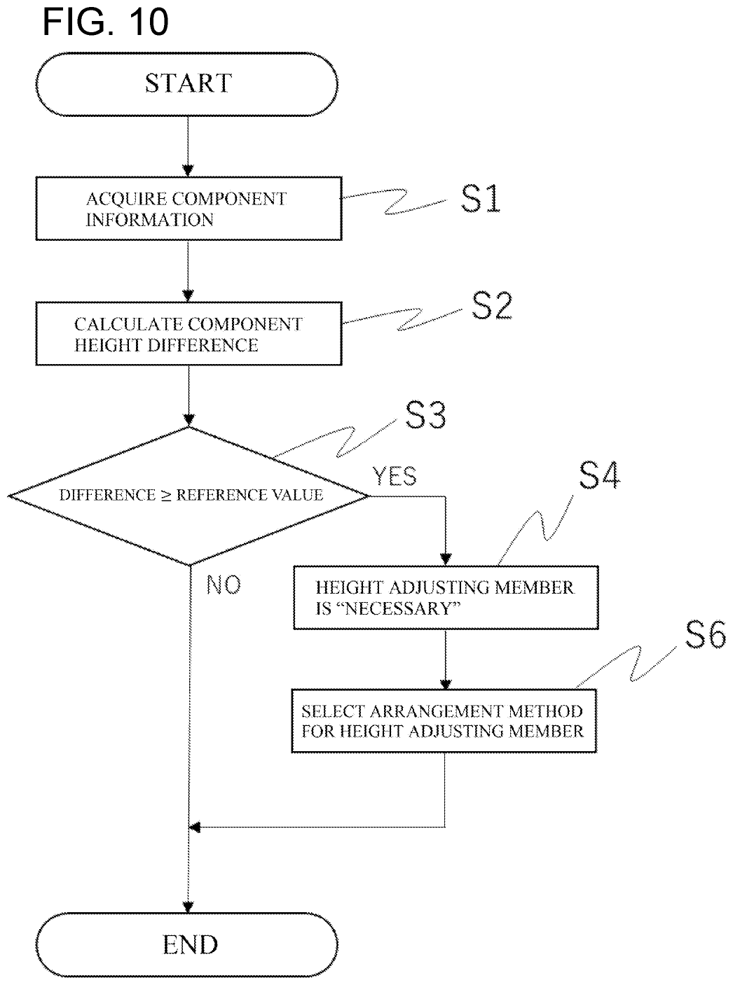

The operation of a design support apparatus 300 (design support method) according to the third embodiment of the disclosure will be described below using FIG. 10. A processing flow of the design support method according to the present embodiment is the same as that of the first embodiment except step S6. In step S6, on the basis of information about a condition for availability of each electronic component stored in advance in the storage unit 191, an arrangement method of arranging a height adjusting member is determined. Table 2 illustrates an example of a combination of a condition for availability of each electronic component and means of determining an arrangement method of arranging a height adjusting member. As illustrated in Table 2, in the present embodiment, if an electronic component where a height adjusting member is to be arranged is available in a wafer state, a plating process is selected as an arrangement method of arranging the height adjusting member, for example. If an electronic component where a height adjusting member is to be arranged is available on an individual basis (as a bare chip), bonding of a metallic plate is selected as an arrangement method of arranging the height adjusting member. The combination of the condition for availability and the arrangement method described above is stored in advance in the storage unit 191.

TABLE 2

| Electronic component | Availability | Arrangement |
|---|---|---|
| identifying information | condition | method |
| Electronic | Wafer state | Plating |
| component A | | process |
| Electronic | Individual basis | Bonding of |
| component B | (bare chip) | metallic plate |

As described above, according to the present embodiment, it is possible to further determine an arrangement method of arranging a height adjusting member efficiently.

According to the embodiments, the function of the design support apparatus 100, 200, or 300 may be realized using hardware. Specifically, the design support apparatus 100, 200, or 300 may include one or two or more processing circuits and the processing circuit may realize the functions of the “units.” The design support apparatus 100, 200, or 300 may be realized using a combination of software and hardware. Specifically, some of the “units” may be realized using software, and the other “units” may be realized using hardware.

Some or all of a plurality of the embodiments described above according to the disclosure may certainly be combined, or some of the constituting elements may certainly be applied to the other embodiment. Such a configuration also belongs to an embodiment of the disclosure.

### INDUSTRIAL APPLICABILITY

The design support apparatus, the design support program, and the design support method of the disclosure are available in any field including semiconductors (such as compound semiconductor electronic devices, for example), electronic components, electric equipment components, optical electrophotographic related apparatuses, and industrial members, and especially useful for electronic component embedded substrates with embedded power devices.

The embodiments of the present invention are exemplified in all respects, and the scope of the present invention includes all modifications within the meaning and scope equivalent to the scope of claims.

### REFERENCE SIGNS LIST

1a Schottky electrode
1b Ohmic electrode
2 Semiconductor layer
11a Emitter electrode
11b Gate electrode
11c Collector electrode
12 Semiconductor layer
20 Component embedded substrate
21 Height adjusting member
23 First semiconductor component (electronic component)
24 Second semiconductor component (electronic component)
25 Substrate (conductive layer)
26 Substrate (conductive layer)
27 Via
28 Resin
100 Design support apparatus
101 Incorporated component information acquiring unit
102 Height difference calculating unit
103 Height adjustment necessity judging unit
104 Height adjusting member dimension calculating unit
105 Height adjusting member arrangement method selecting unit
191 Storage unit
192 Accepting unit
193 Output unit
200 Design support apparatus
300 Design support apparatus
901 Processor
902 Memory
903 Auxiliary storage device
904 Input device
905 Output device

What is claimed is:

1. A design support apparatus that supports design of an electronic component embedded substrate, the apparatus comprising:
a height difference calculating unit that calculates a difference between the height of a first electronic component and the height of a second electronic component on the basis of first component information containing height information about the first electronic component to be incorporated in an electronic component embedded substrate and second component information containing height information about the second electronic component to be incorporated in the electronic component embedded substrate; and
a height adjustment necessity judging unit that compares the difference with a reference value set in advance, and judges the necessity of a height adjusting member to be arranged on the first electronic component and/or the second electronic component.

2. The design support apparatus according to claim 1, wherein
the height adjustment necessity judging unit selects an electronic component where the height adjusting member is to be arranged.

3. The design support apparatus according to claim 1, further comprising:
a height adjusting member dimension calculating unit that calculates a dimension of the height adjusting member.

4. The design support apparatus according to claim 1, wherein
the first electronic component and the second electronic component are bare chips, and the height information about the first electronic component and the height information about the second electronic component are height information about the respective bare chips.

5. The design support apparatus according to claim 1, further comprising:
a height adjusting member arrangement method selecting unit that selects an arrangement method of arranging the height adjusting member.

6. The design support apparatus according to claim 5, wherein
the first component information and the second component information, or the first component information or the second component information contains availability condition information about the first electronic component and/or the second electronic component, and
the height adjusting member arrangement method selecting unit selects the arrangement method of arranging the height adjusting member on the basis of the availability condition information.

7. The design support apparatus according to claim 1, further comprising:
an input device for inputting component identifying information about the first electronic component and component identifying information about the second electronic component.

8. The design support apparatus according to claim 1, comprising:
a component information acquiring unit that acquire component information containing the height information about the first electronic component and the height information about the second electronic component from a component database on the basis of the component identifying information about the first electronic component and the component identifying information about the second electronic component accepted by the input device.

9. The design support apparatus according to claim 1, wherein
the first electronic component and the second electronic component are power devices.

10. The design support apparatus according to claim 1, wherein
the first electronic component is a rectifier element and the second electronic component is a switching element.

11. The design support apparatus according to claim 1, further comprising:
an output device that outputs result of judgment by the height adjustment necessity judging unit.

12. A design support program that supports design of an electronic component embedded substrate, the program causing a computer to perform:
a height difference calculating process of calculating a difference between the height of a first electronic component and the height of a second electronic component on the basis of first component information containing height information about the first electronic component to be incorporated in an electronic component embedded substrate and second component information containing height information about the second electronic component to be incorporated in the electronic component embedded substrate; and
a height adjustment necessity judging process of comparing the difference with a reference value set in advance, and judging the necessity of a height adjusting member.

13. A design support method of supporting design of an electronic component embedded substrate, the method comprising at least:
calculating a difference between the height of a first electronic component and the height of a second electronic component on the basis of first component information containing height information about the first electronic component to be incorporated in an electronic component embedded substrate and second component information containing height information about the second electronic component to be incorporated in the electronic component embedded substrate; and
comparing the difference with a reference value set in advance, and judging the necessity of a height adjusting member.
